(19) United States
(12) Patent Application Publication
(10) Pub. No.: US 2005/0254365 A1
(43) Pub. Date: Nov. 17, 2005

(54) Portable media player

(76) Inventor: Tse Hung Keung, Hong Kong (HK)

Correspondence Address: GOTTLIEB RACKMAN & REISMAN PC, 270 MADISON AVENUE, 8TH FLOOR, NEW YORK, NY, 100160601, US

(21) Appl. No.: 10/835,844

(22) Filed: Apr. 29, 2004

(51) Int. Cl. G11B 5/09

(52) U.S. Cl. 369/47.1; 369/53.1

(57) ABSTRACT

The invention provides a portable media player comprising: a processor; a drive mechanism coupled to said processor, said drive mechanism being adapted to receive a disc having data stored thereon; memory coupled to said processor; an output device coupled to said processor through which an audio signal may be output; said processor being capable of retrieving data from a disc placed in said drive mechanism and of generating an audio signal based on said data; said processor being capable of outputting said audio signal through said output device; wherein said portable media player further comprises: a memory card interface coupled to said processor, said memory card interface being adapted to receive a memory card, said memory card interface being capable of receiving data from and transmitting data to said processor; and a Universal Serial Bus interface coupled to said processor, said Universal Serial Bus interface being adapted to be connected to an external storage device, said Universal Serial Bus being capable of receiving data from and transmitting data to said processor.

### FIELD OF THE INVENTION

The present invention relates to a portable media player. The portable media player comprises means for playback of compact disc (CD) audio discs and, in addition, means for playback of compressed and non-compressed audio files stored on external storage media such as multimedia memory cards (MMCs) and personal computers (PCs). The portable media player of the present invention also permits audio files to be copied from a CD onto external storage media.

### PRIOR ART

Portable media players in the form of CD players are known in the art. Typically, such CD players allow playback of audio data files stored on a CD disc by using a laser to detect data stored on the disc in the form of lands and pits. However, such CD players are not flexible in that they are only able to playback CD-type media.

### SUMMARY OF THE INVENTION

The present invention provides a portable media player comprising:
a processor;
a drive mechanism coupled to said processor, said drive mechanism being adapted to receive a disc having data stored thereon;
memory coupled to said processor;
an output device coupled to said processor through which an audio signal may be output;
said processor being capable of retrieving data from a disc placed in said drive mechanism and of generating an audio signal based on said data;
said processor being capable of outputting said audio signal through said output device;
wherein said portable media player further comprises:
a memory card interface coupled to said processor, said memory card interface being adapted to receive a memory card, said memory card interface being capable of receiving data from and transmitting data to said processor; and
a Universal Serial Bus interface coupled to said processor, said Universal Serial Bus interface being adapted to be connected to an external storage device, said Universal Serial Bus being capable of receiving data from and transmitting data to said processor.

In one aspect said processor is capable of retrieving data from a memory card placed in said memory card interface and of generating an audio signal based on said data and outputting said audio signal through said output device.

In another aspect said processor is capable of retrieving data from an external storage device connected to said Universal Serial Bus interface and of generating an audio signal based on said data and of outputting said audio signal through said output device.

In another aspect said processor is capable of retrieving data from a disc placed in said drive mechanism and of recording said data to a memory card placed in said memory card interface. Alternatively, said processor is capable of retrieving data from a disc placed in said drive mechanism and of recording said data to an external storage device connected to said Universal Serial Bus interface. Further, said processor is capable of retrieving data from a memory card placed in said memory card interface and of recording said data to an external storage device connected to said Universal Serial Bus interface. Alternatively, said processor is capable of retrieving data from an external storage device connected to said Universal Serial Bus interface and of recording said data to a memory card placed in said memory card-interface.

The portable media player may also comprise a microphone interface coupled to said processor, said microphone interface being capable of receiving audio signals from a microphone. Said processor may be capable of retrieving audio signals received by said microphone interface, generating data based on said audio signals and of recording said data to a memory card placed in said memory card interface. Alternatively, said processor may be capable of retrieving audio signals received by said microphone interface, generating data based on said audio signals and of recording said data to an external storage device connected to said Universal Serial Bus interface.

The media player may further comprise an analogue-to-digital converter coupled between said microphone interface and said processor.

The media player may further comprise general-purpose input/output (GPIO) ports coupled to said processor.

Said processor may comprise a digital signal processor.

Preferably, the digital signal processor is capable of encoding and decoding MP3, WMA and CDDA data signals.

Typically, said disc comprises a CD, CDR or CDRW.

Typically, said memory comprises flash memory and/or SDRAM memory.

Typically, said output device comprises a digital-to-analogue converter. In one aspect, the media player further comprises an earphone socket connected to said digital-to-analogue converter.

Typically, said memory card comprises a flash memory card. In a preferred aspect, said flash memory card comprises a Secure Digital (SD) card.

Said external storage device may comprise any of a personal computer, a flash memory drive or a portable storage drive. The invention, in another aspect provides a portable media player comprising:
a processor;
a drive mechanism coupled to said processor, said drive mechanism being adapted to receive a disc having data stored thereon;
memory coupled to said processor;
a digital-to-analogue convertor coupled to said processor through which an audio signal may be output;
said processor being capable of retrieving data from a disc placed in said drive mechanism and of generating an audio signal based on said data;
said processor being capable of outputting said audio signal through said digital-to-analogue convertor;
wherein said portable media player further comprises:
a memory card interface coupled to said processor, said memory card interface being adapted to receive a memory card, said memory card interface being capable of receiving data from and transmitting data to said processor, wherein said processor is capable of retrieving data from a memory card placed in said memory card interface and of generating an audio signal based on said data and outputting said audio signal through said digital-to-analogue convertor;
a Universal Serial Bus interface coupled to said processor, said Universal Serial Bus interface being adapted to be connected to an external storage device, said Universal Serial Bus being capable of receiving data from and transmitting data to said processor, wherein said processor is capable of retrieving data from an external storage device connected to said Universal Serial Bus interface and of generating an audio signal based on said data and of outputting said audio signal through said digital-to-analogue convertor.

Preferably, said processor is capable of retrieving data from a disc placed in said drive mechanism and of recording said data to a memory card placed in said memory card interface or to an external storage device connected to said Universal Serial Bus interface.

Advantageously, the portable media player provides a compact and simple-to-operate device which allows for playback of CDs (or equivalents) as well as compressed audio data stored on external storage devices such as USB-compatible devices and MMCs. The media player also allows recordal of audio signals from an external microphone onto USB-compatible devices and MMCs. Further, the media player allows copying of data sourced from a CD, USB-compatible storage device or MMC onto a USB-compatible storage device or MMC without the need for complicated arrangements of apparatus. Copying of CD-sourced data is particularly advantageous since no separate cables are required to record to an MMC and only a standard USB cable is required to record to a USB-compatible external storage device. Advantageously, the MMC and USB storage devices are detachable from the portable media player. This allows them to be removed and connected to another compatible playback device if desired by the user.

A preferred embodiment of the present invention will now be described, by way of example only, with reference to the accompanying figures, in which:

### BRIEF DESCRIPTION OF THE DRAWINGS

FIG. 1 is a plan view of the portable media player according to the present invention;

FIG. 2 is a perspective view from underneath of the portable media player of FIG. 1;

FIG. 3 is a system block diagram showing system elements of the portable media player of FIG. 1; and

FIG. 4 is a functional block diagram showing functional elements of the portable media player of FIG. 1.

### DESCRIPTION OF THE PREFERRED EMBODIMENT

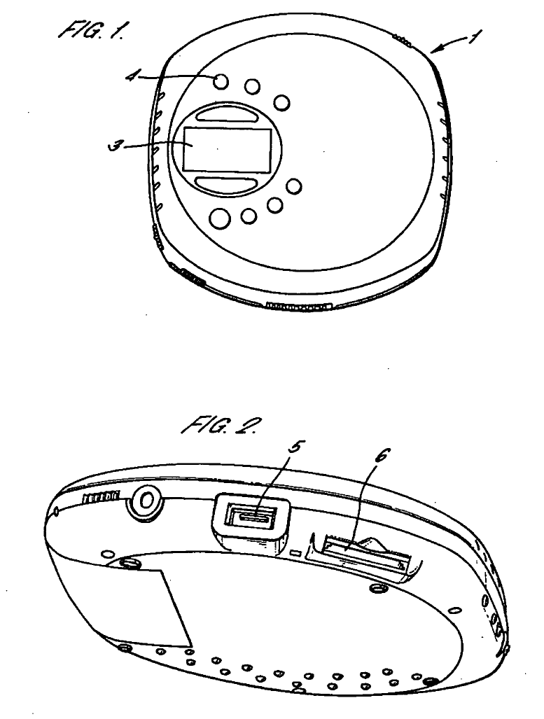

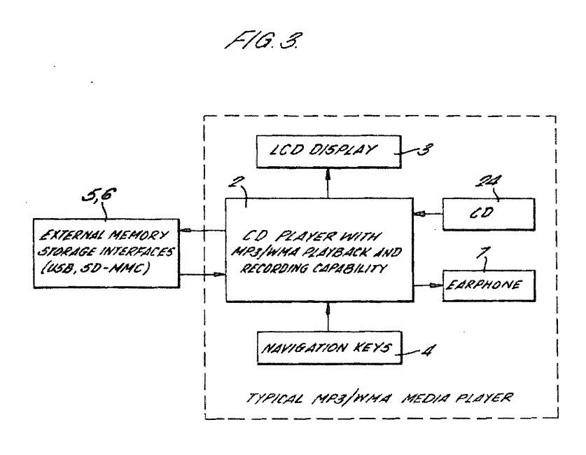

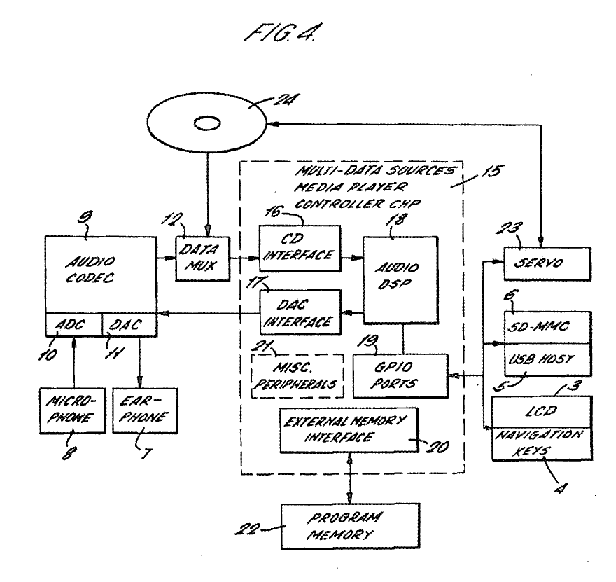

The portable media player 1 of the present invention comprises the functionality of a standard CD player as well as the capability of playback from and recordal to external storage devices using multimedia memory card and/or Universal Serial Bus interfaces. A typical external layout of the portable media player of the present invention is shown in FIGS. 1 and 2. The system layout of the portable media player 1 is shown in FIG. 3.

As shown in FIG. 3, the portable media player 1 of the present invention comprises a unit having CD and audio file playback functionality, navigation/operation keys 4 and a liquid crystal display (LCD) 3. A CD 24 may be inserted and played in the player 1 with the generated audio output being played via earphones connected to an earphones socket 7. Interfaces 5, 6 for Universal Serial Bus (USB) and Multimedia Memory Card (MMC) devices are also provided as part of the player 1, the use of which will be described below.

The CD functionality of the portable media player 1 is provided by provision of a basic CD player unit having a number of components of known form. In particular, as shown functionally in FIG. 4, the basic CD player unit comprises a housing for receiving in use a CD 24, a servo 23 to allow for high speed rotation of the CD 24, a CD reader unit (not shown) including a laser for detecting the data stored on the CD in the form of lands and pits, and a data multiplexer (data MUX) 12 for conveying the detected data to a controller chip 15 of the player 1. The CD player is capable of playing a number or types of CD including pre-recorded CDs, Recordable Compact Discs (CDR) and equivalents and Re-Writable Compact Discs (CDRW) and equivalents.

The controller chip 15 of the media player 1, as shown in FIG. 4, comprises a CD Interface 16, a Digital to Analogue Converter (DAC) Interface 17, an audio Digital Signal Processor (DSP) 18, General Purpose Input/Output (GPIO) ports 19, an External Memory Interface 20 and miscellaneous peripherals 21.

The CD Interface 16 provides an interface between the data MUX 12 and the audio DSP 18 for conveying data read from the CD (or equivalent) to the audio DSP in a form suitable for processing.

The DAC interface 17 provides an interface between the audio DSP 18 and a separate audio coder-decoder (codec) 9 provided in the media player 1.

The audio codec 9 comprises a digital-to-analogue converter (DAC) 11 for converting digital signals output by the DAC Interface 17 into an analogue form suitable to drive the earphones socket 7. The audio codec 9 also comprises an analogue-to-digital converter (ADC) 10 for converting analogue signals received from an external source into a digital form which can be passed to the data MUX 12 and then onto the controller chip 15. In accordance with the present invention the player 1 may be provided with a microphone socket 8 to which may be connected a microphone for detecting external audio signals. The microphone's output is directed to the ADC 10.

The audio DSP 18 performs the functions of signal processing, and the decoding and encoding of audio data. The audio DSP 18 is programmable.

The GPIO ports 19 provide an interface between the audio DSP 18 and components which provide inputs to and receive outputs from the controller chip 15 such as the LCD 3, navigation buttons 4 and the CD servo 23.

The External Memory Interface 20 supports a program memory 22 and a runtime memory. The program memory 22 permanently or semi-permanently stores program data for the audio DSP 18 and is preferably in the form of flash memory. The runtime memory provides on-demand memory capacity for programs during working of the controller chip 15. The runtime memory is preferably in the form of Synchronous Dynamic Random Access Memory (SDRAM).

Miscellaneous peripherals 21 are provided as known in the art of micro-controllers to support functionality of the controller chip 15. These include, for example, timers, Universal Asynchronous Receiver/Transmitter (UART) and Analogue to Digital Converters (ADC).

Operation of the basic CD player unit is controlled by a user though the navigation/operation keys 4 provided on the panel located on the exterior of the housing as shown in FIG. 1. Information on the current status of the media player, and the data being played is provided to the user in a visual form using the LCD 3. Audio signals generated by the portable media player 1 are relayed to the user via the pair of earphones connected to the earphone socket 7 of the player 1. The basic CD player unit may be provided with anti-shock means as known in the art allowing for uninterrupted playback even when the portable media player is jolted or otherwise moved during use.

According to the present invention, the functionality of the basic CD player unit is complemented by provision of means for connecting external storage devices to the media player 1. As shown in FIG. 2, according to the present invention the portable media player 1 is provided on a side surface with a Universal Serial Bus (USB) interface 5. The USB interface 5 allows the media player 1 to be connected to a USB storage device which is provided with a complementary USB interface. A USB cable of known form is used to make the connection between the two USB interfaces. Preferably, the USB interface 5 of the media player is compatible with USB 1.0 and USB 2.0 devices. The USB storage device may be a device such as a portable storage drive, e.g. a Thumb Drive or U-disk. Alternatively, the USB storage device may be a personal computer (PC) having a USB interface. It will be clear that other USB-compatible devices may be used within the scope of the present invention.

The USB storage device may store the audio data in a format such as Moving Pictures Experts Group Layer 3 (MP3), Windows Media Audio (WMA) or Compact Disc Digital Audio (CDDA).

The portable media player 1 further comprises a Multimedia Memory Card (MMC) interface 6. In the illustrated embodiment the MMC interface 6 is a Secure Digital MMC (SD/MMC) interface. The SD/MMC interface 6 allows the connection to the portable media player 1 of an external SD/MMC memory card. As known in the art, the SD/MMC memory card comprises a flash memory which may be used to store audio data in, for example, MP3, WMA or CDDA formats.

Both the USB interface 5 and the SD/MMC interface 6 are connected to the GPIO ports 19 of the controller chip 15. In this way data may be passed between the external storage devices connected to the interfaces 5, 6 and the audio DSP 18 on the controller chip 15.

In use, the media player 1 allows the playback of audio data from CDs (or equivalent), USB storage devices and MMCs. Control of operation of the USB storage devices and MMCs is provided by the navigation/operation keys 4.

Where the playback media is a CD, operation is the same as with a normal portable CD player. Data read from the CD is directed to the audio DSP 18 via the data MUX 12 and CD interface 16 of the controller chip 15. The audio DSP 18 processes the received signals dependant on the data type. For example, the data may be in CDDA, WMA or MP3 formats. The processed output from the audio DSP 18 (in Pulse Code Modulation (PCM) format) is directed to the earphones socket 7 via the audio codec 9 to generate the audible playback signals.

Where the playback media is a USB compatible device or an MMC, the data read from the external storage device is directed to the audio DSP 18 via the GPIO ports 19. As with CD media, the audio DSP 18 processes the received signals dependant on the data type. Typically, the data will be in WMA or MP3 formats. The processed output from the audio DSP 18 (in PCM format) is directed to the earphones socket 7 via the DAC 11 of the audio codec 9 to generate the audible playback signals.

It will be understood that the playback signals may be used to drive internal or external speakers rather than a pair of earphones via the earphone socket 7.

In use, the media player 1 further allows the recording of audio data to external USB-compatible storage devices and MMCs.

Where the source of the data to be recorded is a microphone, analogue signals from the microphone are input, through the microphone socket 8, into the ADC 10 of the audio codec 9. The signals are converted into digital form and passed to the audio DSP 18 via the data MUX 12 and CD interface 16 of the controller chip 15. The audio DSP 18 processes the received signals, typically involving at least compressing and encoding the digital signals into WMA or MP3 formats. The compressed signals are than directed to either the MMC interface 5 or the USB interface 6 for recordal onto an external storage device connected to the relevant interface.

Where the source of the data to be recorded is a CD, digital signals read from the CD in a known manner are input via the data MUX 12 and CD interface 16 to the audio DSP 18 of the controller chip 15. The audio DSP 18 processes the received signals, typically involving at least compressing and encoding the digital signals into WMA or MP3 formats. The compressed signals are than directed to either the MMC interface 5 or the USB interface 6 for recordal onto an external storage device connected to the relevant interface.

It is also possible to record signals stored on one external storage device to another external storage device using the media player 1. A first external storage device containing the source data is connected to one or other of the USB interface 6 or MMC interface 5. A second external storage device is connected to the free interface. Data may then be read from the first, source, device by the audio DSP 18 via the GPIO ports 19. The signals may then be passed back and recorded onto the second device again via the GPIO ports 19. Optionally, the audio DSP 18 may carry out processing on the signals prior to recording onto the second device.

1. A portable media player comprising:
a processor;
a drive mechanism coupled to said processor, said drive mechanism being adapted to receive a disc having data stored thereon;
memory coupled to said processor;
an output device coupled to said processor through which an audio signal may be output;
said processor being capable of retrieving data from a disc placed in said drive mechanism and of generating an audio signal based on said data;
said processor being capable of outputting said audio signal through said output device;
wherein said portable media player further comprises:
a memory card interface coupled to said processor, said memory card interface being adapted to receive a memory card, said memory card interface being capable of receiving data from and transmitting data to said processor; and
a Universal Serial Bus interface coupled to said processor, said Universal Serial Bus interface being adapted to be connected to an external storage device, said Universal Serial Bus being capable of receiving data from and transmitting data to said processor.

2. A portable media player as claimed in claim 1 wherein said processor is capable of retrieving data from a memory card placed in said memory card interface and of generating an audio signal based on said data and outputting said audio signal through said output device.

3. A portable media player as claimed in claim 1 wherein said processor is capable of retrieving data from an external storage device connected to said Universal Serial Bus interface and of generating an audio signal based on said data and of outputting said audio signal through said output device.

4. A portable media player as claimed in claim 1 wherein said processor is capable of retrieving data from a disc placed in said drive mechanism and of recording said data to a memory card placed in said memory card interface.

5. A portable media player as claimed in claim 1 wherein said processor is capable of retrieving data from a disc placed in said drive mechanism and of recording said data to an external storage device connected to said Universal Serial Bus interface.

6. A portable media player as claimed in claim 1 wherein said processor is capable of retrieving data from a memory card placed in said memory card interface and of recording said data to an external storage device connected to said Universal Serial Bus interface.

7. A portable media player as claimed in claim 1 wherein said processor is capable of retrieving data from an external storage device connected to said Universal Serial Bus interface and of recording said data to a memory card placed in said memory card interface.

8. A portable media player as claimed in claim 1 further comprising a microphone interface coupled to said processor, said microphone interface being capable of receiving audio signals from a microphone.

9. A portable media player as claimed in claim 8 wherein said processor is capable of retrieving audio signals received by said microphone interface, generating data based on said audio signals and of recording said data to a memory card placed in said memory card interface.

10. A portable media player as claimed in claim 8 wherein said processor is capable of retrieving audio signals received by said microphone interface, generating data based on said audio signals and of recording said data to an external storage device connected to said Universal Serial Bus interface.

11. A portable media player as claimed in claim 8 further comprising an analogue-to-digital converter coupled between said microphone interface and said processor.

12. A portable media player as claimed in claim 1 further comprising general-purpose input/output (GPIO) ports coupled to said processor.

13. A portable media player as claimed claim 1 wherein said processor comprises a digital signal processor.

14. A portable media player as claimed in claim 13 wherein the digital signal processor is capable of encoding and decoding MP3, WMA and CDDA data signals.

15. A portable media player as claimed in claim 1 wherein said disc comprises a CD, CDR or CDRW.

16. A portable media player as claimed in claim 1 wherein said memory comprises flash memory and/or SDRAM memory.

17. A portable media player as claimed in claim 1 wherein said output device comprises a digital-to-analogue converter.

18. A portable media player as claimed in claim 17 further comprising an earphone socket connected to said digital-to-analogue converter.

19. A portable media player as claimed in claim 1 wherein said memory card comprises a flash memory card.

20. A portable media player as claimed in claim 19 wherein said flash memory card comprises a Secure Digital (SD) card.

21. A portable media player as claimed in claim 1 wherein said external storage device comprises any of a personal computer, a flash memory drive or a portable storage drive.

22. A portable media player comprising:
a processor;
a drive mechanism coupled to said processor, said drive mechanism being adapted to receive a disc having data stored thereon;
memory coupled to said processor;
a digital-to-analogue convertor coupled to said processor through which an audio signal may be output;
said processor being capable of retrieving data from a disc placed in said drive mechanism and of generating an audio signal based on said data;
said processor being capable of outputting said audio signal through said digital-to-analogue convertor;
wherein said portable media player further comprises:
a memory card interface coupled to said processor, said memory card interface being adapted to receive a memory card, said memory card interface being capable of receiving data from and transmitting data to said processor, wherein said processor is capable of retrieving data from a memory card placed in said memory card interface and of generating an audio signal based on said data and outputting said audio signal through said digital-to-analogue convertor;
a Universal Serial Bus interface coupled to said processor, said Universal Serial Bus interface being adapted to be connected to an external storage device, said Universal Serial Bus being capable of receiving data from and transmitting data to said processor, wherein said processor is capable of retrieving data from an external storage device connected to said Universal Serial Bus interface and of generating an audio signal based on said data and of outputting said audio signal through said digital-to-analogue convertor.

23. A portable media player as claimed in claim 22 wherein said processor is capable of retrieving data from a disc placed in said drive mechanism and of recording said data to a memory card placed in said memory card interface or to an external storage device connected to said Universal Serial Bus interface.
